(19) United States
(12) Patent Application Publication
(10) Pub. No.: US 2025/0170653 A1
(43) Pub. Date: May 29, 2025

(54) LIFT SYSTEM FOR BINDER JETTING ADDITIVE MANUFACTURING

(71) Applicant: Desktop Metal, Inc., Burlington, MA (US)

(72) Inventors: Kurt JOUDREY, Burlington, MA (US); Eric WALKAMA, Burlington, MA (US); Chuck MARTIN, Burlington, MA (US); Alexander COSTA, Burlington, MA (US); Emanuel SACHS, Burlington, MA (US); John SNIDER, Burlington, MA (US); Matthew NAPLES, Burlington, MA (US)

(21) Appl. No.: 18/839,748

(22) PCT Filed: Feb. 15, 2023
(86) PCT No.: PCT/US2023/013088

§ 371 Date: Aug. 20, 2024

Related U.S. Application Data
(60) Provisional application No. 63/312,291, filed on Feb. 21, 2022.

(51) Int. Cl. B22F 12/00; B22F 10/14; B22F 12/90; B33Y 10/00; B33Y 30/00

(52) U.S. Cl. CPC B22F 12/222; B22F 10/14; B22F 12/38; B22F 12/90; B33Y 10/00; B33Y 30/00

(57) ABSTRACT

A lifting system for a binder jetting additive manufacturing printer including a lift enclosure having a sealable access port and an aperture between an interior of the lift enclosure and a printing chamber. At least one lift column fixed to the interior of the lift enclosure is configured to vertically traverse a build box lift plate from a retracted position to a raised position, wherein in the raised position the build box lift plate indexes against at least one indexing stop. A platen lift is affixed to the box lift plate and is configured to traverse a build platen in a z-lift axis.

### RELATED APPLICATIONS

This application is a US National Stage Application, filed under 35 U.S.C. § 371, of International Application PCT/US2023/013088, filed on Feb. 15, 2023 and claims priority to U.S. Patent Application 63/312,291, filed on Feb. 21, 2022; the contents of the above applications are incorporated by reference herein in their entirety.

### TECHNICAL FIELD

Various aspects of the present disclosure relate generally to systems and methods for facilitating binder jetting additive manufacturing.

### BACKGROUND OF THE DISCLOSURE

Binder jetting is an additive manufacturing technique by which a thin layer of powder (e.g. 65 μm) is spread onto a bed, followed by deposition of a liquid binder in a 2D pattern or image that represents a single “slice” of a 3D shape. After deposition of binder, another layer of powder is spread, and the process is repeated to form a 3D volume of bound material within the powder bed. These processes are typically performed by a binder jetting printer (commonly referred to as “printer” or “3D printer” in this disclosure). After printing, the bound part may be, in reversible order, cured or crosslinked to strengthen the binder, and removed from the excess build material powder.

It is necessary for this process to move a build platen incrementally relative to the jetting and powder distribution apparatuses as the successive layers are manufactured. This must be accomplished with high precision otherwise imperfections will be imparted to the part. Simultaneously, it is desirable to have an easy system by which the build box containing the bound part and excess powder may be inserted into the binder jetting printer and removed following printing operations, while also allowing for adequate cleaning of loose powder in parts of the system which represent potential health and safety hazards.

### SUMMARY

Disclosed is a lift assembly facilitating the installation and articulation of a build box and a build platen for binder jetting additive manufacturing. An enclosure for the lift assembly may be subject to a flow of process gas independently or in conjunction with a printing area inside a printer. A sealable access port permits the installation and extraction of a build box. An aperture between an interior of the lift enclosure and a printing chamber allows a build platen to be presented to a binder jetting apparatus.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure.

FIG. 1 depicts a component schematic diagram of a binder jetting printer for use with embodiments of the present disclosure.

FIG. 2 depicts a cutaway view of the binder jetting printer of FIG. 1.

FIG. 3. is a schematic view of a first alternative binder jetting carriage assembly.

FIG. 4 is a schematic view of a second alternative binder jetting carriage assembly.

FIG. 5 is a perspective view of a binder jetting printer.

FIGS. 6A-F depict a side cutaway schematic view of a Z-lift assembly during its phases of operation according to an exemplary embodiment of the present disclosure.

FIGS. 7A-D depict a Z-lift assembly according to an exemplary embodiment of the present disclosure.

FIGS. 8A-E depict a first indexing stop.

FIGS. 9A-E depict a second indexing stop.

FIG. 10 depicts an interface between the first and second indexing stops.

FIG. 11 depicts a configuration of index stops configured to kinematically mount a build box lift plate.

FIG. 12 depicts build platen interface of a platen lift.

### DETAILED DESCRIPTION

In the process of binder jetting additive manufacturing, a build material powder is delivered to and spread upon a build surface and a binding agent (or binder or ink) is deposited on the build material powder to at least partially bind the build material powder to form a slice of a 3D object. By repeating the steps of delivering a build material powder, spreading a build material powder, and depositing a binder corresponding to a desired image, a 3D structure may be formed. This process is understood to occur in a binder jetting printer (or binder jet printer).

In certain embodiments, a binder jet printer may comprise a print enclosure with a number of modules configured to aid in or accomplish the additive manufacturing of parts and other objects from a build material powder. These modules may include: (1) an assemblage of printheads (or one printhead in certain embodiments), (2) an ink delivery system to supply the printheads with binder at flow and pressure conditions necessary for stable binder ejection from the printhead, (3) a build material supply module to deliver an amount of build material powder to a print surface (also referred to as a work plane) within the printer, (4) a build material spreading module to spread an amount of build material powder which has been supplied to a print surface to a controlled thickness, (5) a container and motion system to contain the build material powder (commonly referred to as a build box) and during printing move the container to specific positions (e.g., by moving in a first direction relative to a least one of the modules (1)-(4)) to enable the fabrication of successive layers of an object. In some embodiments, the printer may comprise additional modules including: (6) devices configured to reduce, prevent, or remove build material powder and/or ejecta from the printhead that may become suspended in an atmosphere in the print enclosure, including, according to certain embodiments, devices which deposit liquids (e.g., water, alcohol, oils, and the like) onto a surface of the build material powder to alter the cohesive characteristics of the powder, devices which control and/or provide a flow of gas to remove and/or filter suspended ejecta, (7) devices configured to control the gaseous atmosphere within the print enclosure relative to a gaseous atmosphere surrounding the binder jet printer, and (8) at least one reciprocating mechanism to provide relative motion between the container containing build material powder and at least one of the modules (1) to (4) in a second direction different from the first direction of the container and indexing system. In some embodiments, a cart may be used to transport, move, or store the build box from the printer to subsequent processing operations, including a crosslinking (or heating or curing step), a depowdering step, or a storage location. The cart may be designed to raise and lower the build box to interface with the printer or other processing equipment.

Build material powders may be sensitive to certain gaseous atmospheres. According to certain embodiments, it is desirable to prevent, minimize, or otherwise avoid gaseous communication between certain gaseous species and specific metal powders. For example, a copper build material powder may oxidize when in contact with air. In certain embodiments of the binder jetting printing process, such an oxidation of copper may be deleterious to the printing process for at least the reason that the oxidation may be uncontrolled and may introduce uncertainty into certain aspects of the binder jet printing process. In certain embodiments, a build material powder may be reactive (e.g, pyrophoric or explosible) with moisture and the build material powder should be kept separate from a base level of moisture contained in ambient air (e.g., room humidity). In certain embodiments, a build material powder may not be chemically sensitive (e.g., prone to oxidation, explosibility, pyrophoricity, or other means of chemical reaction) but may exhibit a change in physical properties such as the ability of the build material powder to flow. In the case where the flow characteristics of the powder will vary, degrade, or otherwise change, maintaining a consistent atmosphere around the build material powder may be required.

In another embodiment, build material powders may be reactive (e.g. pyrophoric or explosible) in the presence of oxygen and ignition sources capable of providing energy above the minimum ignition energy or temperatures above the minimum ignition temperature of the powder. Certain of the process modules (1) to (8) may provide sufficient energy or temperature to exceed these ignition limits, creating a condition in which a reaction may occur. In such cases, it may be desirable to maintain the printing environment in an inerted state, with the oxygen concentration of the atmosphere maintained below a predetermined concentration which is lower than the limiting oxygen concentration, or the concentration below which combustion of the build material powder does not readily occur. A typical target oxygen concentration may be 2%, which is below a typical limiting oxygen concentration of 4-15% for commonly printed materials.

In the process of binder jet additive manufacturing, a build material powder is typically supplied to a binder jet printer and some amount of this build material powder is bound using a binder to form objects. These objects are provided with various names in the field of art, and may be referred to as green parts, but are sometimes also referred to as brown parts. In certain embodiments, the objects formed may include parts that, as one skilled in the art will appreciate, may undergo subsequent post-processing steps (perhaps including a curing, drying, or crosslinking step) to improve the mechanical properties (such as strength, fracture toughness, elongation to failure, and the like) of the bound object.

### Post-Processing

In certain embodiments, post-processing (such as curing, drying, crosslinking, and the like) may be optionally performed to improve the mechanical properties of objects fabricated from build material powder and binder. In certain embodiments, the improvement of mechanical properties attained during the post-processing steps may reduce breakages of objects that can occur during the removal of unbound build material powder from the surfaces of the objects formed from binder and build material powder. This process of removing unbound build material powder (that is, powder which is not held or adhered to an object with binder) is often termed “depowdering”. As one skilled in the art may appreciate, several approaches may be pursued to depowder parts.

### Objects: Parts and Supports

Several types of objects may be printed using a binder jet printer. In certain embodiments, a single object may comprise a single part. In certain embodiments, a single object may comprise a series of parts connected with a mechanical linkage permitting relative motion (such as a hinge, slide, or other element). In certain embodiments, a single object may comprise a series of parts connected with a mechanical linkage in which motion is prohibited, substantially prohibited, or the parts are otherwise fully constrained in all directions of translation and rotation. In certain embodiments, a single object may comprise a series of parts connected with at least one mechanical linkage permitting motion in at least one direction, and prohibiting motion in at least one other direction (such as, for example, in a sliding mechanism permitting motion in a first sliding direction with constraint imposed in a second constraining direction orthogonal to the first direction). In certain embodiments, a single object may comprise a part and a supporting structure, where the supporting structure may be configured to touch, abut, hold, cradle, or otherwise contact the part at or through at least one point across opposed surfaces of the part and support structure. In certain embodiments, the support structure may provide a means of support to the part. In certain embodiments, the means of support may be mechanical, such that the support structure, through the at least one point, carries a stress or force transmitted through or imposed upon the part. In certain embodiments, the part and the support may be printed in a first configuration and brought to contact in a second configuration, where the second configuration enables the support structure to provide support to the part.

### Thermal Processing

Following binder jet printing and optional post-processing of the object, the object may be further subjected to thermal processing, according to certain embodiments. The thermal processing may include the steps of debinding and sintering of the object.

### Debinding

During debinding, binder is removed from the object. Debinding may be performed in any suitable chamber or enclosure. In certain embodiments, a suitable chamber or enclosure may include a means of heating the object, a means of providing a flow of process gas, a means of evacuating a process gas, and a means of controlling a pressure of the process gas, as will be appreciated by one skilled in the art.

Not being bound by theory, debinding may remove binder by a thermally activated process of evaporation, sublimation, combustion, oxidation, or degradation, according to certain embodiments. Depending upon the specific binder and build material powder materials in the object undergoing debinding, the debinding process may be tailored to achieve the desired amount of debinding.

In certain embodiments, the debinding process may begin at any temperature from the list of starting debinding temperatures: 200, 250, 300, 350, 400, or 450 degrees centigrade. In certain embodiments, the debinding process may end at any temperature from the list of ending debinding temperatures: 250, 300, 350, 400, 500, or 600 degrees centigrade. For example, a debind process may occur between 200 and 350 degrees centigrade, or may occur between 300 and 600 degrees centigrade. It should be understood by one skilled in the art that the starting debinding temperature will be less than the ending debinding temperature.

The debinding process may require the maintenance of a specific gaseous atmosphere surrounding the objects, according to certain embodiments. The gaseous atmosphere may include the gases argon, nitrogen, oxygen, hydrogen, helium, carbon dioxide, carbon monoxide, ammonia, methane, air, or the like. According to certain embodiments, the gaseous atmosphere may be a mixture of gases. According to certain embodiments, the gaseous atmosphere may be substantially absent and a vacuum may exist about the parts. According to certain embodiments, a gaseous atmosphere may be provided by a process gas.

The debinding process may require, or more optimally perform with a specific pressure or range of pressures of a process gas. According to certain embodiments, the pressure of the gaseous atmosphere during debinding may be equal to or may exceed 1 atmosphere. According to certain embodiments, the pressure of the gaseous atmosphere during debinding may be between 0.5 and 1 atmosphere. According to certain embodiments, the pressure of the gaseous atmosphere may be between 0.01 and 0.5 atmospheres. According to certain embodiments, the pressure of the gaseous atmosphere may be between 0.01 and 10 Torr. According to certain embodiments, the pressure of the gaseous atmosphere may be less than 0.01 Torr. In certain embodiments, a desired pressure may be maintained with a vacuum pump and a supply of process gas, where the volume of gas removed by the pump and the supply of process gas at least partially determine the pressure within the debind chamber.

### Sintering

Following the removal of at least a portion of the binder by the debinding process, the object may then be sintered, according to certain embodiments. In certain embodiments, the objects may be sintered without the removal of the binder, or without the binder removal step.

Not being bound by theory, during the process of sintering, the build material powder is heated to result in the joining of the build material powders to form a sintered object. The sintered object may exhibit a density larger than the density of the object prior to sintering, according to some embodiments. The object may be sintered without the melting of any build material powder, according to certain embodiments. The object may be sintered with the melting of only a portion of the build material powder, according to certain embodiments.

The process of sintering typically occurs in a sintering furnace, as will be appreciated by one skilled in the art. According to some embodiments, the sintering furnace may include a means of heating the object to be sintered. According to some embodiments, the sintering furnace may include a means of providing a flow of sintering process gas to the objects to be sintered, in such a way that the gaseous atmosphere around the objects to be sintered is at least partially controlled. According to some embodiments, the sintering furnace may include a means of controlling the pressure of a gaseous atmosphere around the objects during the sintering process (the “sintering pressure”). According to some embodiments, the means of controlling the pressure of a gaseous atmosphere around the objects during sintering may include a vacuum pump and at least one conduit to enable gaseous communication between a chamber housing the object to be sintered and the vacuum pump.

The gaseous atmosphere surrounding the object during sintering is often an important aspect of the sintering process. According to certain embodiments, the gaseous atmosphere may be comprised of hydrogen, helium, argon, nitrogen, carbon dioxide, carbon monoxide, methane, forming gas (a mixture of hydrogen and argon), ammonia, or air. According to certain embodiments, the gaseous atmosphere may be comprised of a mixture of gasses (95% nitrogen and 5% hydrogen by weight, for example). Careful selection of the gaseous atmosphere may promote certain mechanisms of sintering and lead to a desired amount of densification. As will be understood by one skilled in the art, the composition of the gaseous atmosphere surrounding the object during sintering may change during the sintering process, for example according to a predetermined schedule and in a coordinated fashion with the temperature, pressure, and flow rates as a function of time.

The pressure of the gaseous atmosphere surrounding the object during sintering is often an important aspect of the sintering process. According to certain embodiments, it is desirable to decrease the pressure in the sintering furnace to enhance the densification (that is, to increase the density) of an object undergoing sintering. According to certain embodiments, it is desirable to increase the pressure in the sintering furnace to enhance the densification (that is, to increase the density) of an object undergoing sintering. The selection of pressure is typically determined by the elements from which the build material powder is comprised in addition to the interaction of the elements with the gaseous atmosphere. In certain embodiments, the pressure of the gaseous atmosphere surrounding the object during sintering is at least 1 atmosphere and up to 5 atmospheres. In certain embodiments, the pressure of the gaseous atmosphere surrounding the object during sintering is at least 0.5 atmosphere and less than 1 atmosphere. In certain embodiments, the pressure of the gaseous atmosphere surrounding the object during sintering is at least 0.1 atmosphere and less than 0.5 atmosphere. In certain embodiments, the pressure of the gaseous atmosphere surrounding the object during sintering is at least 0.001 Torr atmosphere and less than 10 Torr. In certain embodiments, the pressure of the gaseous atmosphere surrounding the object during sintering is less than 0.001 Torr. As will be understood by one skilled in the art, the pressure of the gaseous atmosphere surrounding the object during sintering may change during the sintering process, for example according to a predetermined schedule and in a coordinated fashion with the temperature, composition, and flow rates as a function of time.

In some embodiments, the steps of debinding and sintering may occur during a sequentially in the same chamber, as part of a processing operation. For example, a single furnace may be used to first debind a part by controlling its temperature through starting and ending debind temperatures, and continuing to sintering temperatures without first cooling the part from the ending debind temperature.

### Build Material Powders

In certain embodiments, the build material may be any finely divided material or powder. The finely divided material may be a metal, oxide ceramic, non-oxide ceramic, glass, cermet, organic material, carbide, nitride, or any mixture, according to certain embodiments.

In certain embodiments, the build material may comprise a metallic powder. In certain embodiments, the metallic powder may comprise a pure element (such as elemental copper or iron). In certain embodiments, the metallic powder may comprise an alloy of metallic elements to form a specific grade of metal, such as 17-4 stainless steel, 316 stainless steel, 316L stainless steel, 4140 low alloy steel, Inconel 718, Inconel 625, 6061 aluminum, 7075 aluminum, Ti-6Al-4V titanium, F75 Co—Cr—Mo, or any other alloy capable of being produced in a powdered or finely-divided form. In certain embodiments, the metallic powder may comprise a mixture of powdered metallic elements purposed to achieve the desired chemical specification of an alloyed metal (for example, a mixture including elemental Co, Cr, and Mo powders to form an F75 alloy, or a mixture including Fe, Cr, V, C, Mn, Si, and Ni to form a stainless steel). In certain embodiments, the build material may comprise a metallic powder where the metal is a refractory metal (such as tungsten, tantalum, niobium, rhenium, molybdenum, hafnium, zirconium, or the like).

In certain embodiments, the build material may comprise a ceramic powder. In certain embodiments, the ceramic powder may comprise alumina, zirconia, yittria-stabilized zirconia, mullite, silica, chromia, spinel, and the like. In certain embodiments, the build material may be a mixture of ceramic powders (for example, silica and alumina, or magnesium oxide and alumina).

In certain embodiments, the build material may be naturally derived, as an organic material. In certain embodiments, the organic material may comprise a wood flour, sawdust, cellulosic fiber, or the like.

In certain embodiments, a binder jet printer may include a container to contain the build material powder and printed structures. The container may be moveable relative to the build material delivery and spreading mechanisms, and may also be indexable relative to an inkjet head or heads which deposit the binding agent in a desired pattern to form a slice of a 3D structure on the surface of a powder bed. As may be appreciated by one skilled in the art, the ability of the binder jet printer to accurately position and index the bed is crucial to the performance of the binder jet printer, and, specifically, is crucial to the layer-to-layer tolerance of the objects (or parts) produced by the binder jet printer.

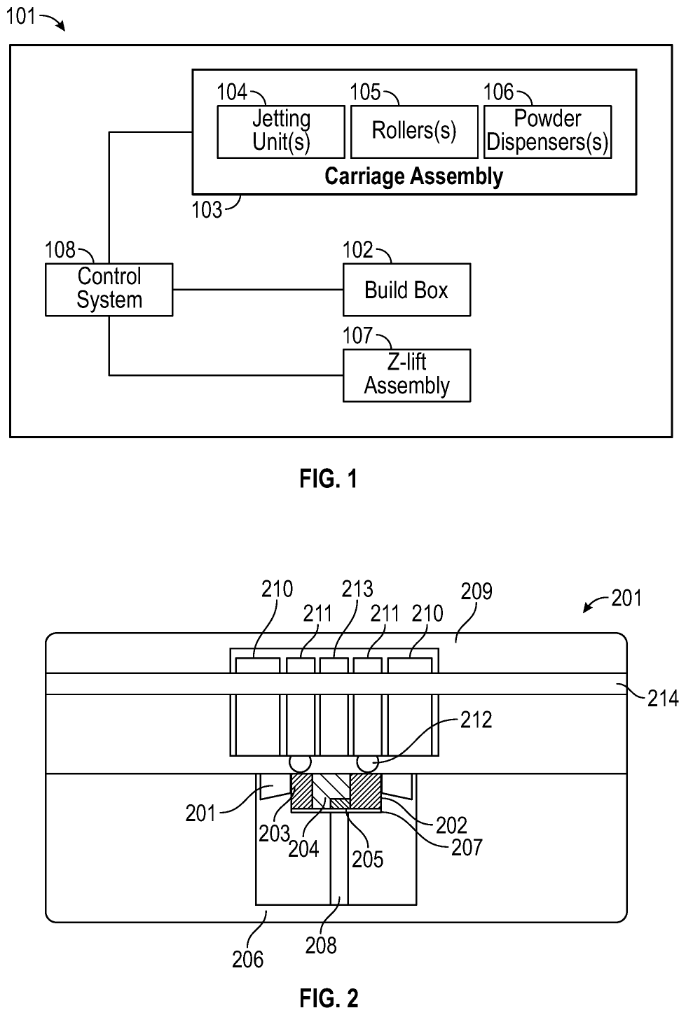

With reference to FIG. 1, a binder jetting printer 101 includes a build box 102 where a part is to be manufactured. A carriage assembly 103 is moved relative to the build box 102 to deposit successive layers of build material powder and binder to form parts. In certain embodiments, the binder jetting printer 101 can be used to manufacture metal parts. In these instances, the build material powder is metal powder, and the part is later sintered to densify the part. The carriage assembly includes jetting unit(s) 104 for depositing binder, roller(s) 105 for spreading powder layers prior to binder jetting and powder dispenser(s) 106 which meter build material powder for successively printed layers. In alternate embodiments, build material powder may be metered from feed piston and spread across the build box. In the embodiment of FIG. 1, the printer 101 includes a lift assembly 107 which moves a build platen within the build box down as successive layers are printed. A control system 108 controls the various elements of the binder jetting printer 101.

FIG. 2 depicts a side cutaway view of a binder jetting printer 201. A build box 202 contains loose powder 203 and a part 204 being manufactured and potentially support structures 205. A lift assembly 206 is configured to raise and lower the build box and build platen 207 to facilitate the printing process. A lift 208 raises and lowers a build platen 207. A print carriage 209 traverses relative to the build box. In the depicted embodiment, the carriage 209 moves while the build box 202 is maintained in a static position, though the build box 202 could alternatively move while the carriage 209 is maintained in a static position. In the depicted embodiment, the carriage 209 includes an arrangement of components for use in jetting. In the embodiment, printing is bi-directional, i.e., in a first direction—left to right with reference to the figure, and then from right to left. To facilitate bi-directional printing, the depicted carriage 209 includes powder dispensing units 210, powder roller units 211 having rollers 212 and a jetting unit 213. The powder dispensing units 210 and powder roller units 211 alternate depending on the printing direction so that powder is dispensed ahead of the roller which distributes the powder before the single jetting unit 213 deposits binder. Rail system 214 facilitates the movement of print carriage 209.

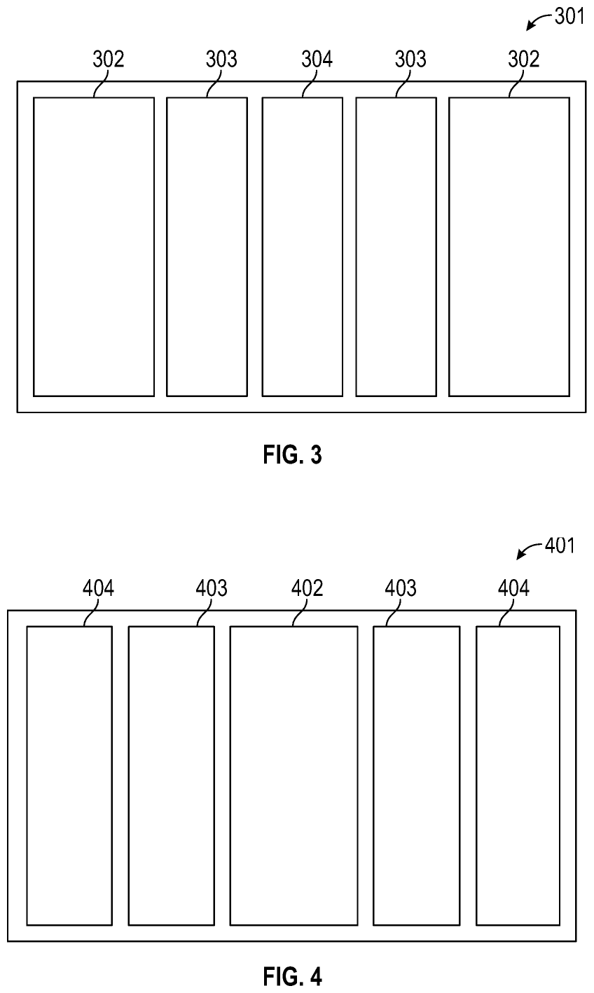

FIG. 3 depicts an alternative arrangement of printing components in a carriage 301, including powder dispensing units 302, jetting units 303 and a roller unit 304.

FIG. 4 depicts an alternative arrangement of printing components in a carriage 401, including a powder dispensing unit 402, jetting units 403 and jetting units 404.

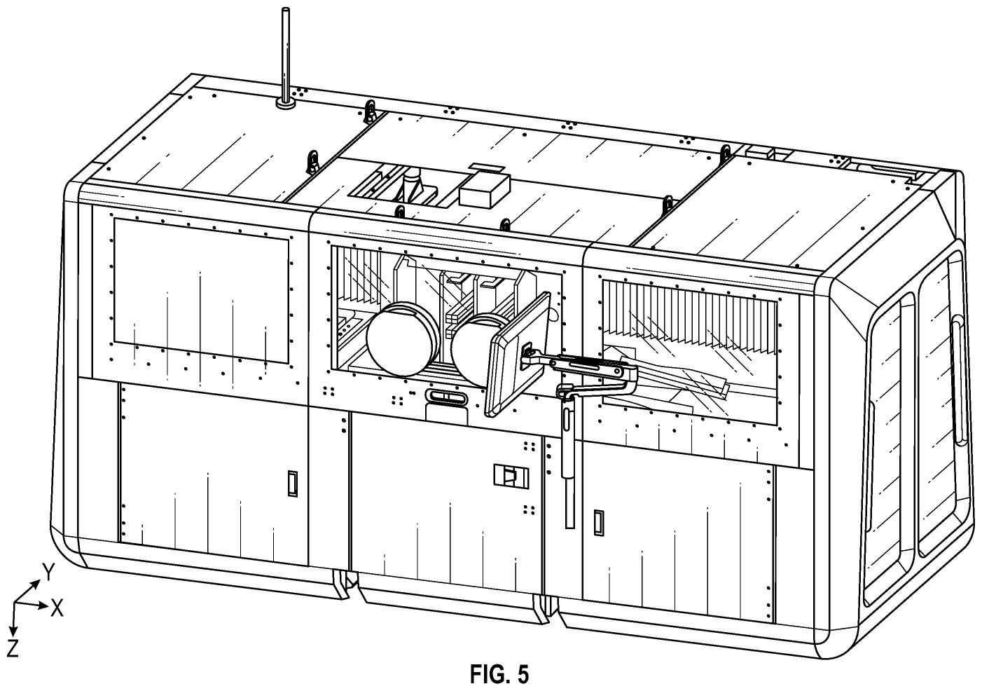

FIG. 5 depicts an exterior perspective view of a binder jetting printer as may be used with embodiments of the disclosure.

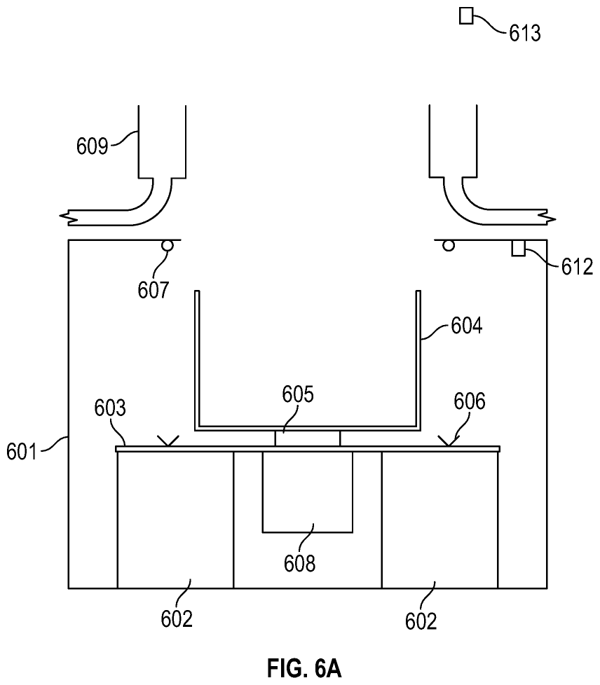

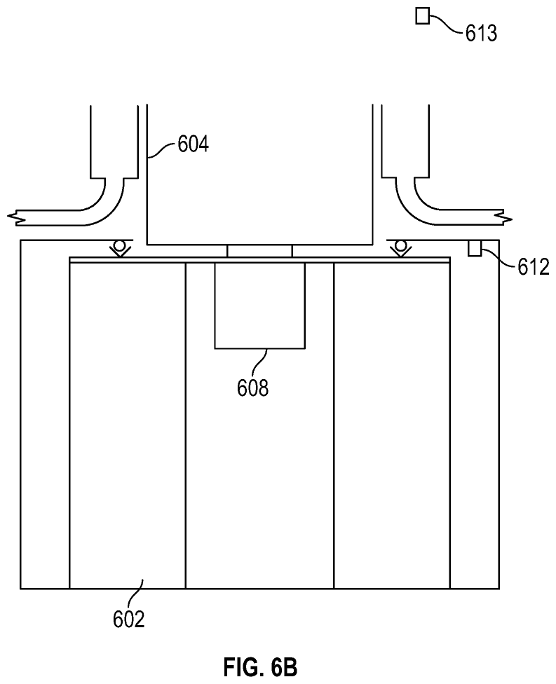

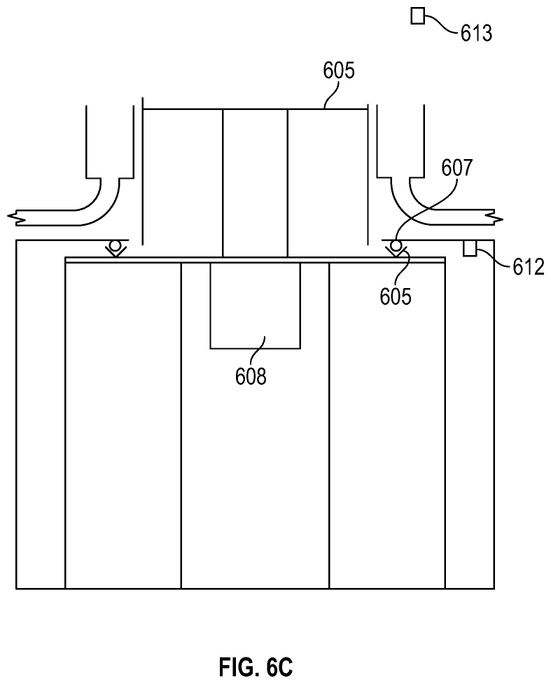

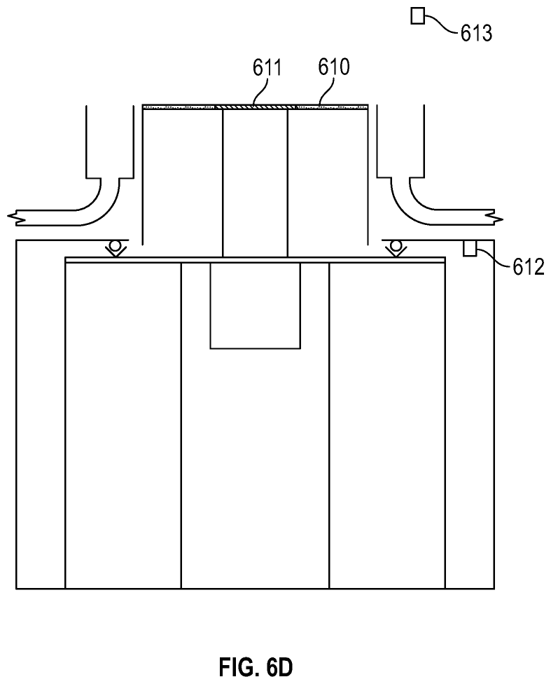

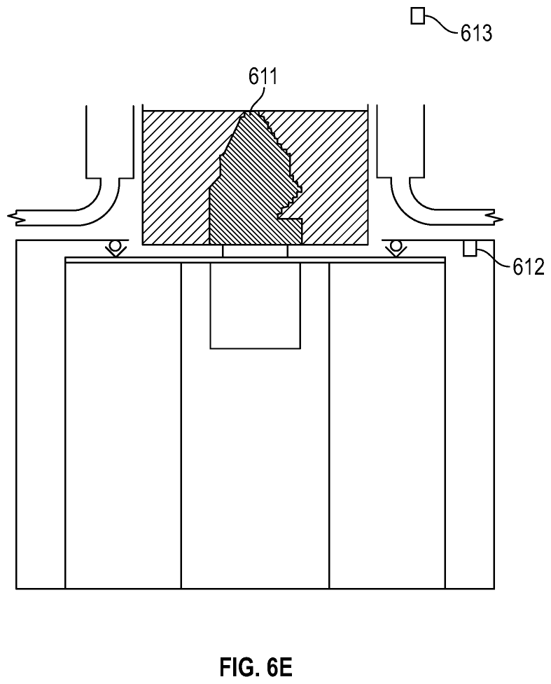

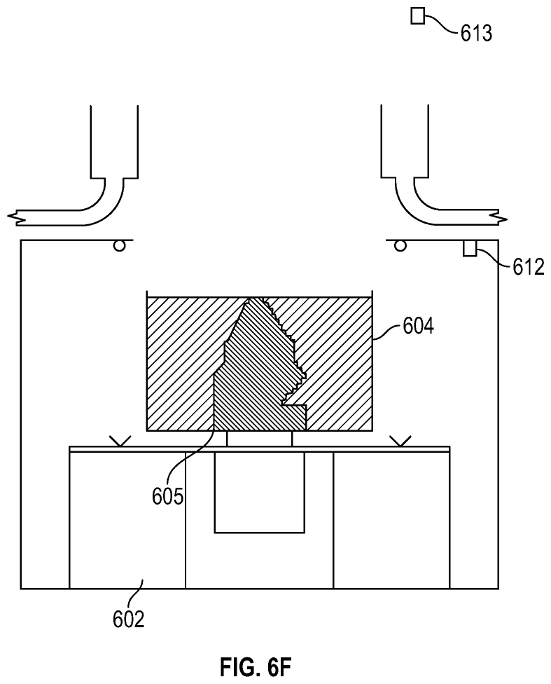

FIG. 6A depicts a side cutaway schematic view of an embodiment Z-lift assembly. A lift enclosure 601 is sealable relative to an ambient environment via a sealable access port (not pictured). Lift columns 602 are fixed to the interior of lift enclosure 601 and are configured to vertically traverse a build box lift plate 603. In alternate embodiments, one or more than two lift columns may be employed. The use of two lift columns allows the build box not to be cantilevered, avoiding undesirable deflection and providing a stable platform for creating the printing surface. In FIG. 6A, the build box lift plate 603 is in a retracted position that facilitates installation and removal through an aperture (not pictured) of the build box 604 and build platen 605 which together contain parts as they are printed. A first set of indexing points 606 is configured to interface with a second set of indexing points 607 when the build box lift plate is in a raised position (see FIG. 6B). A platen lift 608 is affixed to the build box lift plate 603 and configured to traverse the build platen 605 during a printing process along the z-lift axis (in FIG. 6A, up and down). A downdraft system 609 is configured to receive excess powder that is dislodged from a build surface during the printing processes. The downdraft system is connected to a powder collection unit (not pictured). A first pressure sensor 612 measures an atmospheric pressure in the Z-lift enclosure 601. A second pressure 613 measures atmospheric pressure in a printing chamber. These measurements permit the measurement of a differential pressure between the Z-lift enclosure 601 and the printing chamber which can be used to ensure a higher pressure in the print chamber such that air or oxygen admitted to the Z-lift enclosure 601 during the opening of the Z-lift enclosure (for example to install a build box) does not flow into the print chamber (which could resulting in an undesirable increase of oxygen or air in the print chamber).

FIG. 6B depicts the lift columns 602 in a raised position. This positions the build box 604 for a printing operation. Indexing stops 606 and 607 index the build box lift plate 603 precisely, presenting the build box 604 to the printing operation in a manner that is repeatable with a high degree of accuracy, while being insensitive to the repeatable accuracy of the lift columns 602. This permits the use of lower-cost lift columns for moving of the build box into and out of position while still maintaining high accuracy placement of the build box, which may be necessary for accurate printing. FIG. 6C depicts the platen lift 608 having traversed the lift platen 605 to a deployed position where it is ready to receive a first layer of build material powder for printing.

FIG. 6D. predicts a first layer of powder 610 having been deposited and a first layer of a part 611 having been printed as a pattern of binder. After each successive layer is printed, the platen lift 608 lowers the build platen by an amount to allow a new layer to be printed. In an embodiment, a layer thickness for printing may be between 20 μm and 250 μm. In some embodiments, during the lowering of the build platen by the platen lift, the platen lift may lower the build platen by a distance greater than the layer height (for example, 500 μm), and subsequently raise the build platen by the distance required such that the new position is lower than the starting position by the layer thickness. For example, if a layer thickness of 50 μm is desired, the platen lift may first move the build platen down by 500 μm and then up by 450 μm, such that the net motion resulting is a 50 μm downward motion. In this manner, the effects of friction, backlash, and other sources of inaccuracy may be minimized, resulting in a more accurate positioning of the build platen. FIG. 6E depicts a completed print job in which a part 611 is suspended in loose powder. In FIG. 6E, the number of layers accommodated in a typical build box is greatly reduced and the layers are depicted as separated to promote understanding.

FIG. 6F depicts that following a printing operation, the build box 604 may be lowered by lift columns 602 so that it may be removed along with the build platen through the sealable access port.

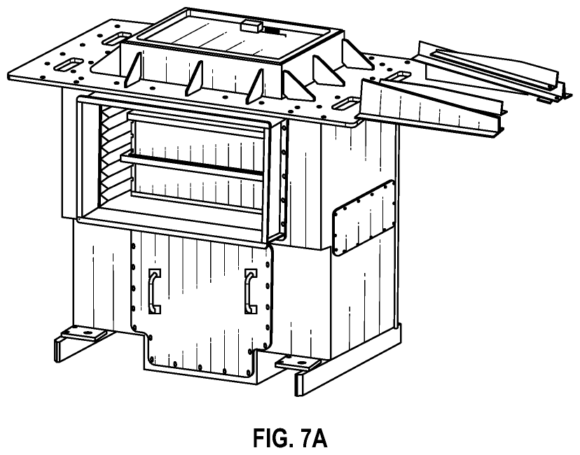

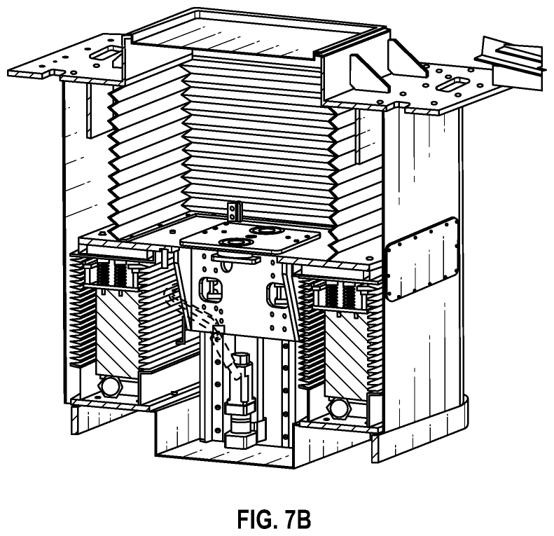

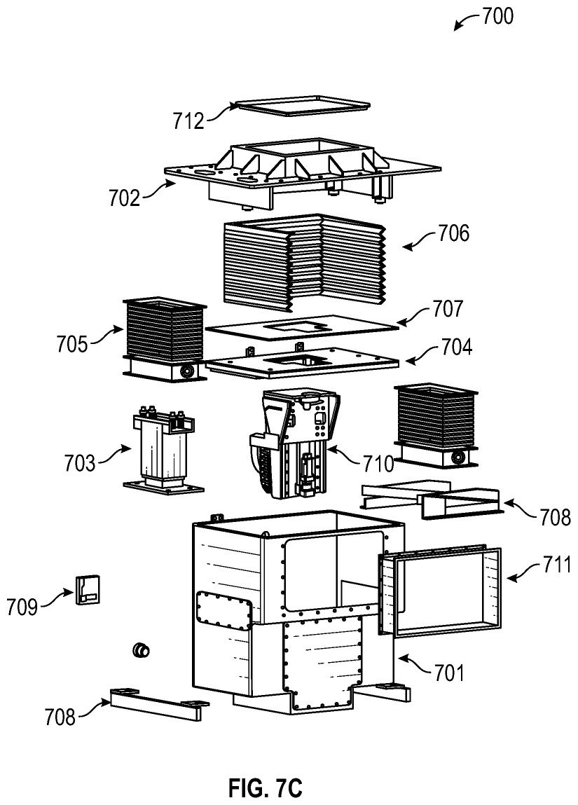

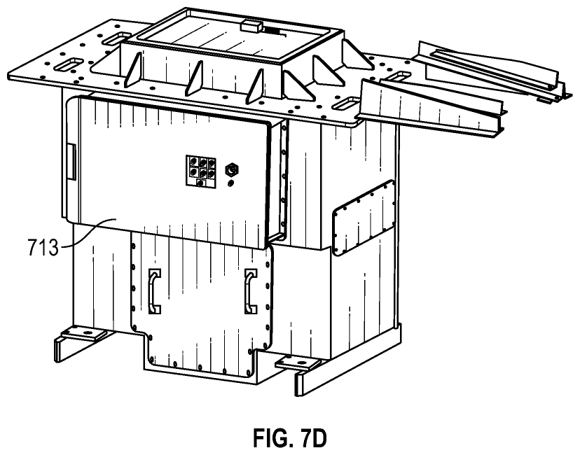

FIG. 7A depicts a demonstrated embodiment Z-lift assembly 701 for integration with a binder jetting printer such as the binder jetting printer of FIG. 5. FIG. 7B depicts a cutaway view of the Z-lift assembly 701.

FIG. 7C depicts an exploded view of the Z-lift assembly 700. Together the gas box 701 and deal seal plate 702 may constitute a Z-lift enclosure. Two lift columns 703 are configured to lift build box lift plate 704. Each of the lift columns 703 include a bellow arrangement 705 sealed at a bottom surface and at an upper surface to the deck seal plate 702. The bellow arrangements 705 help to isolate the mechanisms of the lift columns 703 from powder contamination. Similarly, a second bellow arrangement 706 sealed between the build box lift plate 704 and the deck seal plate 702 limit powder migration from printing operations. A wipe down sheet 707 is configured for ease of cleaning after printing operations. A lid tray 708 serves as a safe storage location for an aperture plate 712 and a build box lid (not pictured) when they are not installed (for example, during a printing process). The build box lid seals the collection of parts and loose build material powder for transit or storage. Cart guides 708 serve to align a build box cart with the Z-lift assembly for picking up the build box and build platen (not pictured), for subsequent removal from the printer and transfer to post-printing processes. An IO panel 709 may supply electrical, pneumatic, or other inputs and outputs to the Z-lift assembly to provide power and control signals to the lift columns, platen lift, valves, and other active components of the Z-lift assembly. A platen lift 710 is configured to traverse a build platen (not pictured). A door frame 711 supports a sealable door configured to isolate the Z-lift assembly from ambient air. An aperture plate 712 is configured to seal the deck seal plate 702 thus isolating the Z-lift enclosure from a build chamber, for example when a build box is not installed, or when a build box is not in a raised position. Thus the Z-lift enclosure and build chamber may be separately purged with a process gas. FIG. 7D depicts a sealable door 713 having been closed to seal the Z-lift assembly 700 to prevent gaseous communication between an interior of the Z-lift enclosure and an ambient environment.

In certain embodiments, a build box may comprise a series of side walls, a bottom plate (sometimes referred to as a build platen), and a lid, where the bottom plate may move vertically (up and down) along or against the direction of gravity, and the side walls may be oriented perpendicular to both the bottom plate and the lid. In certain embodiments, a sealing material may be provided at certain locations within the build box to prevent or impede egress, spillage, or motion of powder beyond the extents of the build box. In certain embodiments, a sealing material may be placed, installed, or otherwise affixed to remain at locations where relative motion will occur between portions of the build box (such as, for example, a wall of the build box and a bottom plate of a build box. In some embodiments, the felt may be attached to the perimeter of the bottom plate such that it is disposed between the outer extent of the bottom plate and the side walls. In certain embodiments, a sealing material may be placed, installed, or otherwise affixed to remain at locations where portions of the build box are brought into contact and removed from contact, such as between a wall of the build box and a top plate of a build box.

In certain embodiments, the carriage may deflect from a desired vertical position relative to the build platen, for example because build material powder is added to a hopper. The Z-lift assembly may be used to accommodate such a deflection, for example by lowering the build platen relative to the carriage to accommodate for the carriage being lower than desired. The amount of this deflection may be made according to a sensor identifying a specific deviation or according to a model of deflection according to other parameters.

The selection of a sealing material is non-trivial, as the sealing material may be exposed to a variety of thermal, chemical, and mechanical degradation mechanisms, in certain embodiments. Since, in certain embodiments, the build box may be exposed to temperatures and for times during a curing or crosslinking process that may lead to degradation of standard sealing materials (such as rubber, for example). In certain embodiments, mechanical forces from repeated relative motion alone or combined with the abrasive action of build material powder may preclude the use of standard sealing elastomers (e.g., silicones, fluoropolymers, and the like). In certain embodiments, elastomers may be excluded for reasons of cost.

In certain embodiments, a felt, felt-like, textile, or textile-like material may be utilized as a sealing material. In certain embodiments, graphite felt may be used, such as pan graphite felt, In other embodiments, a felt may be composed partly or primarily of an aramid, meta-aramid, or similar material in felt form. In some embodiments, the felt may be attached to a mechanism which applies an outward compressive force against the felt, towards the side wall of the build box. This arrangement may be desirable since the felt may take a thermal set (that is, irreversibly compress, shrink, or densify) under the combination of pressure and temperature experienced during a crosslinking step. In some embodiments, the mechanism providing a force the felt may comprise a spring or series of springs disposed between the felt and the bottom plate.

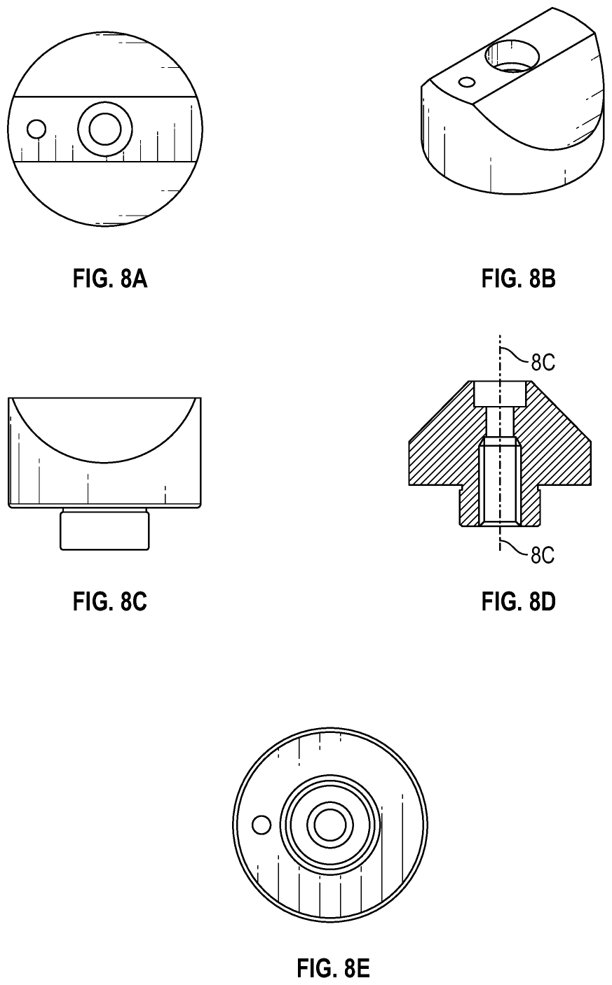

FIGS. 8A is a top plan view of a first index stop. FIG. 8B is a perspective view of the first index stop. FIG. 8C is a side view of the first index stop. FIG. 8D is a side cutaway view of the first index stop. FIG. 8E is a bottom view of the first index stop.

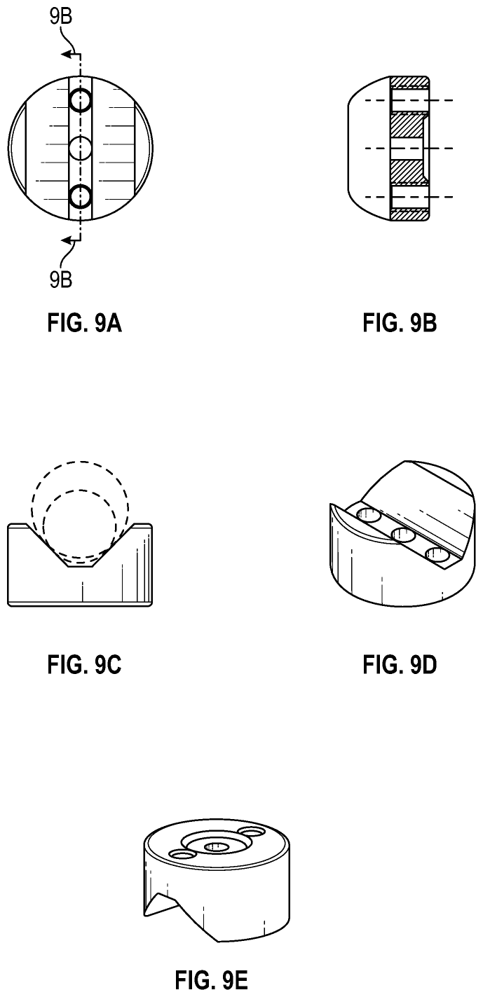

FIGS. 9A is a top plan view of a second index stop. FIG. 9B is a side cutaway view of the second index stop. FIG. 9C is a side view of the second index stop. FIG. 9D is a perspective view of the second index stop. FIG. 9E is a second perspective view showing the bottom of the second index stop.

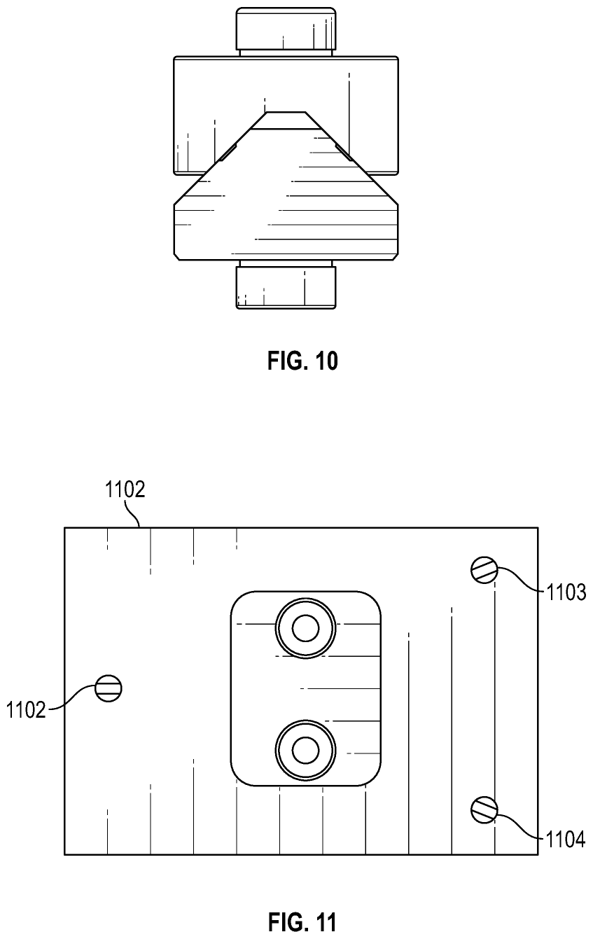

FIG. 10 depicts the first index stop and second index stop indexed together.

FIG. 11 depicts a second indexing configuration on a build box lift plate 1101. A first index stop 1102, a second index stop 1103 and a third index stop 1104 are each in a different orientation selected such that together when they index with complementary features (such as those depicted in FIGS. 9A-E) on the build box (not pictured), the build box is kinematically mounted and repeatably positioned with respect to the Z-lift assembly.

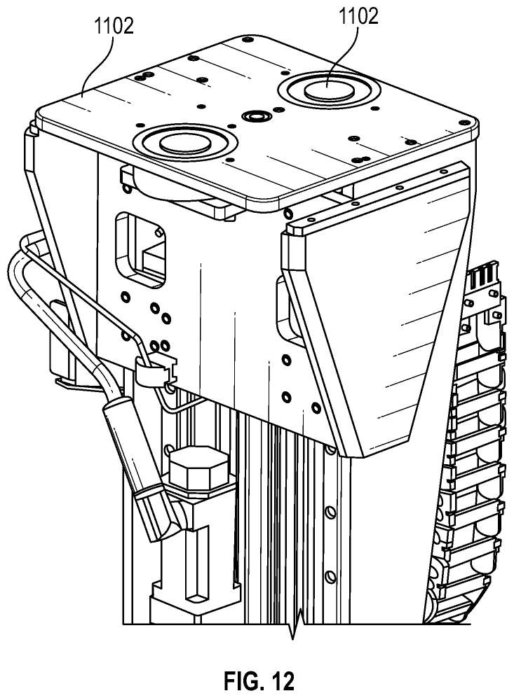

FIG. 12 depicts a platen lift plate 1101 having electromagnets 1102 that are configured to interface with and index a build platen during a printing operation. The one or more magnets may be sized to ensure that the build platen maintains mechanical connection with the platen lift during raising and lower, sufficient to overcome frictional or other impeding forces. When the build plate is made from a material that will block magnetic fields the electromagnets will not affect the build material powder contained in the build box. A plurality of magnets may be used to prevent rotation of the build platen relative to the platen lift plate. As will be understood by one skilled in the art, other anti-rotation features may be envisioned, such as interlocking mechanical features in conjunction with a magnet. Additionally, other hold-down mechanisms may be envisioned, such as vacuum or mechanically interlocking elements (e.g. dovetails) to releasably attach the build platen to the platen lift plate.

What is claimed is:

1. A lifting system for a binder jetting additive manufacturing printer, comprising:
a lift enclosure having a sealable access port and an aperture between an interior of the lift enclosure and a printing chamber;
at least one lift column fixed to the interior of the lift enclosure and configured to vertically traverse a build box lift plate from a retracted position to a raised position, wherein in the raised position the build box lift plate indexes against at least one indexing stop; and
a platen lift affixed to the box lift plate and configured to traverse a build platen in a z-lift axis.

2. The lifting system of claim 1 wherein the build platen interfaces with a plurality of features of the platen lift and serves as a bottom of a build box disposed on the box lift plate.

3. The lifting system of claim 1 wherein in a first condition the build box lift plate is in the retracted position and the build box is accessible from an ambient environment via the sealable access port.

4. The lifting system of claim 1 wherein in a second condition the build box lift plate is in the raised position and the platen lift is configured to successively lower the build platen during a binder jetting additive manufacturing process.

5. The lifting system of claim 1 wherein the build platen is constrained to the platen lift with a magnetic source and at least one indexing stop.

6. The lifting system of claim 1 wherein the at least one indexing stop includes a plurality of adjustable hard stops configured to index to complementary features on the build box lift plate such that the build box lift plate is kinematically mounted with respect to the lift enclosure.

7. The lifting system of claim 1 wherein the at least one lift column includes first a first lift column and a second lift column wherein the platen lift is disposed between the first lift column and the second lift column.

8. The lifting system of claim 7 further comprising a plurality of expandable bellow walls surrounding at least a portion of each of the first lift column and the second lift column.

9. The lifting system of claim 1 further comprising a plurality of expandable bellow walls disposed between an upper surface of the interior of the lift enclosure and the box lift plate.

10. The lifting system of claim 1 further comprising a sensor system configured to measure a differential pressure between the lift enclosure and the printing chamber.

11. The lifting system of claim 1 wherein the lift enclosure is gaseously isolated from the printing chamber when an aperture plate is installed in the aperture.

12. The lifting system of claim 1 wherein the build box is kinematically mounted to the build box lift plate.

13. A method of utilizing a build box for binder jetting additive manufacturing, comprising:
installing a build box onto a build box lift plate inside a lift enclosure;
wherein the build box lift plate is mounted to at least one lift column and wherein a build platen is aligned with a platen lift that is connected to the build box lift plate;
operating the at least one lift column to move the build box lift plate from a retracted position to a raised position wherein an upper portion of the build box is aligned with a work plane in a printing chamber via an aperture in the lift enclosure;
operating the platen lift to align a work surface of the build platen with the work plane; and
operating the platen lift to successively lower the build platen as an additive manufacturing process is conducted.

14. The method of claim 13, further comprising:
following operating the platen lift to successively lower the build platen, operating the at least one lift column to lower the build box lift plate to the retracted position.

15. The method of claim 13, further comprising sealing the aperture with an aperture plate after the additive manufacturing process is conducted.

16. The method of claim 15 further comprising monitoring a differential pressure between the lift enclosure and the printing chamber.

17. The method of claim 13, further comprising inerting the lift enclosure prior to operating the platen lift as the additive manufacturing process is conducted.

18. A lifting system for binder jetting additive manufacturing, comprising:
a build box lift system configured to traverse between a retracted position and a deployed position;
wherein in the deployed position the build box lift system disposes a build box in a predetermined orientation wherein an upper surface of the build box aligns with a work plane; and
a platen lift connected to the build box lift system and configured to traverse a lift platen within the build box.

19. The lifting system of claim 17 wherein the build box lift system is configured to kinematically mount when in the deployed position.

20. The lifting system of claim 17 wherein the build box lift system and the platen lift are contained within a lift enclosure.
